(19) United States
(12) Patent Application Publication
(10) Pub. No.: US 2012/0257403 A1
(43) Pub. Date: Oct. 11, 2012

(54) ILLUMINATION DEVICE FOR A MOTOR VEHICLE AND MOTOR VEHICLE

(75) Inventor: Ralf WILFERT, Buettelborn (DE)

(73) Assignee: GM GLOBAL TECHNOLOGY OPERATIONS LLC, Detroit, MI (US)

(21) Appl. No.: 13/441,143

(22) Filed: Apr. 6, 2012

(30) Foreign Application Priority Data
Apr. 8, 2011 (DE) 10 2011 016 401.4

(51) Int. Cl. B60Q 1/00; F21V 7/00; F21V 29/00; F21V 1/00

(52) U.S. Cl. 362/516; 362/459; 362/509

(57) ABSTRACT

An illumination device includes, but is not limited to at least one light-conductor plate and at least one light source. The at least one light-conductor plate includes, but is not limited to a first main surface and a first lateral surface. In addition, the at least one light-conductor plate includes, but is not limited to light-decoupling elements at least in a part region of the volume of the at least one light-conductor plate. The at least one light-conductor plate is arranged in an outer region of the motor vehicle and forms a decorative shaped part of the motor vehicle. Light of the at least one light source can be coupled into the at least one light-conductor plate via the first lateral surface and can be at least partially decoupled from the at least one light-conductor plate with the light-decoupling elements via the first main surface.

### CROSS-REFERENCE TO RELATED APPLICATION

This application claims priority to German Patent Application No. 10 2011 016 401.4, filed Apr. 8, 2011, which is incorporated herein by reference in its entirety.

### TECHNICAL FIELD

The technical field relates to an illumination device for a motor vehicle and a motor vehicle with at least one illumination device.

### BACKGROUND

From DE 103 40 723 A1 a front region of a motor vehicle is known, in particular of a motor vehicle with an ornamental element for covering the air inlet for the engine cooling unit. In addition, the front region comprises lighting elements, where at least one lighting element is embodied as a vehicle headlamp arranged in pairs and at least one further lighting element is embodied as a side-marker lamp arranged in pairs. The side-marker lamp arranged in pairs is integrated in the ornamental element. Light from light sources arranged in a marginal region of the ornamental element is coupled into light-conducting elements and conducted through these. Decoupling elements in the form of prisms moulded on in the rearward region of the light-conducting elements decouple the light on the surface of the light-conducting element located opposite the decoupling elements.

At least one object is to state a further improved illumination device for the motor vehicle and a motor vehicle with at least one illumination device, which additionally have a high distinguishing power or a recognizing effect. In addition, other objects, desirable features and characteristics will become apparent from the subsequent summary and detailed description, and the appended claims, taken in conjunction with the accompanying drawings and this background.

### SUMMARY

An illumination device is provided for a motor vehicle comprising at least one light-conductor plate and at least one light source. The at least one light-conductor plate comprises a first main surface and a first lateral surface. In addition, the at least one light-conductor plate comprises light-decoupling elements at least in a part region of the volume of the at least one light-conductor plate. The at least one light-conductor plate is arranged in an outer region of the motor vehicle and forms a decorative shaped part of the motor vehicle. Light of the at least one light source can be coupled into the at least one light-conductor plate via the first lateral surface and by means of the light-decoupling elements can be decoupled at least partially from the at least one light-conductor plate via the first main surface.

At least one light-conductor plate comprises light-decoupling elements at least in a part region of the volume of the light-conductor plate. The light-decoupling elements are thus integrated in the light-conductor plate, as a result of which an expensive surface processing of the light-conductor plate for providing decoupling structures can be omitted. Through the light-decoupling elements within the light-conductor plate, the coupled-in light is deflected, as a result of which a total reflection in the light-conductor plate is overcome and the light can at least partially exit from the light-conductor plate via the first main surface.

In addition, because of the embodiment of the at least one light-conductor plate as decorative shaped part and the type of the lighting according to the mentioned embodiment, the illumination device has a high distinguishing power or a recognition effect. Here and in the following, a decorative shaped part is to mean an ornamental element having a specific shaping, imparting to a beholder a special, in particular visual impression and thus makes possible a particular recognition value. Thus it is possible to provide a brand or model-specific identification feature that gives the motor vehicle a particular appearance both during the day as well as during the night or in darkness.

Here, the illumination device in an embodiment can be designed exclusively as decorative element. In this configuration, the illumination device thus does not form a part of the vehicle lighting already present in the vehicle, i.e., no part of the usual light-related devices of the motor vehicle.

In an embodiment, the at least one light-conductor plate comprises PMMA (polymethyl methacrylate). Furthermore, the at least one light-conductor plate as light-decoupling elements, preferably comprises light-defusing nanoparticles. The mentioned components advantageously make possible to provide an even lighting for the brake lamp. Light-defusing nanoparticles in this case and in the following is to mean particles with a diameter of approximately 0.01 to approximately 0.5 micrometers, which defuse the incident light largely isotropically. Here, preferentially colorless particles with a refractive index that differs from that of the remaining material of the light-conductor plate by approximately 0.06≦Δn≦approximately 0.4 is selected, which are distributed in the volume. The nanoparticles can be additionally surrounded by an envelope layer which improves the embedding. Through the embedding of the light-defusing nanoparticles, a material is obtained, which in the non-illuminated state is largely transparent, while in the case of light being coupled in via the first lateral surface, shows an effective light radiation.

The at least one light source can be arranged adjacent to the first lateral surface. This makes possible a particularly simple coupling-in of the light of the at least one light source in the at least one light-conductor plate. Furthermore, the illumination device can additionally comprise at least one light conductor. The at least one light source in this configuration is arranged adjacent to the at least one light conductor. The light of the at least one light source can be coupled into the at least one light-conductor plate with the at least one light conductor via the first lateral surface. This configuration makes possible arranging the at least one light source further spaced from the light-conductor plate. Because of this, the at least one light source can be arranged for example outside a deformation zone of the motor vehicle.

In addition to this, the at least one light-conductor plate can additionally comprise a second main surface located opposite the first main surface. The at least one light-conductor plate comprises a reflector on the second main surface. Thus, a light loss is reduced or avoided through the second main surface facing away from the first main surface. The second main surface in this case can be arranged parallel to the first main surface. Preferably, the reflector comprises a semi-transparent coating. The semi-transparent coating or mirror-finish is for example applied by means of metal vapour deposition. This makes possible a simple manufacture of the reflector. The at least one light source is preferably embodied as light-emitting diode. This makes possible a space-saving arrangement of the at least one light source and a cost-effective lighting.

The at least one light-conductor plate is preferably embodied polygon-shaped, for example cuboid-shaped. Furthermore, the at least one light-conductor plate can be embodied ring-shaped or form a closed ring structure. Thus, a plurality of different shapes can be provided for the light-conductor plate, as a result of which the design freedom or the design possibilities for the illumination device is or are advantageously expanded. Preferably, the at least one light-conductor plate is additionally produced with an injection-molding method. In an embodiment, the light-decoupling elements are homogeneously distributed in the at least one light-conductor plate. This makes possible a cost-effective manufacture of the light-conductor plate.

In an alternative embodiment, an arrangement density of the light-decoupling elements increases from the first lateral surface of the at least one light-conductor plate in the direction of a second lateral surface of the at least one light-conductor plate located opposite the first lateral surface. A corresponding distribution of the light-decoupling elements can improve the even radiation of decoupled light.

In a further configuration, the at least one light-conductor plate is embodied transparently and the at least one light source for the emission of light in a first colour. Here and in the following, “color” is to mean a certain portion within the visible light spectrum. Thus, the colour of the light decoupled from the at least one light-conductor plate via the first main surface in this configuration is determined by the colour of the light emitted by the at least one light source. Here, the at least one light source can directly emit light in the first colour or the at least one light source has a coating by means of which the first colour is provided. Alternatively, the at least one light source can be designed for emitting white light.

In a further embodiment, the at least one light-conductor plate comprises a coloured material. In this configuration, the light decoupled from the at least one light-conductor plate via the first main surface is determined by the colouring of the light-conductor plate. The at least one light source in this configuration can be embodied for emitting light in the colour that is the same as that of the material of the at least one light-conductor plate or be embodied for emitting white light.

A motor vehicle is also provided that has at least one illumination device according to anyone of the preceding embodiments. The at least one illumination device in an embodiment is arranged in a lateral outer region of the motor vehicle. This region is particularly suitable for attaching a brand or model-specific identification feature. Preferably, the at least one illumination device in this case forms an ornamental moulding of the motor vehicle. In a further embodiment, the at least one illumination device is arranged in a front region of the motor vehicle. This region is likewise highly suitable for attaching a brand or model-specific identification feature.

In a further embodiment, the at least one illumination device in this case is arranged adjacent to an air inlet opening for providing ambient air for at least one heat exchanger of the motor vehicle. The at least one heat exchanger is preferably selected from the group consisting of an engine cooling unit, an air conditioning condenser for a refrigerant of an air-conditioning system and a charge air cooler of the motor vehicle. Because of this, an element already present in the motor vehicle is employed in a particularly advantageous manner for attaching a brand or model-specific identification feature in the form of the at least one light-conductor plate, which forms a decorative shaped part of the motor vehicle. Preferably, the at least one light-conductor plate surrounds the air inlet opening in this case. The at least one light-conductor plate can in particular enclose the air inlet opening.

In a further embodiment, the at least one illumination device forms a daytime running lamp of the motor vehicle. Furthermore, the at least one illumination device can form a parking light lamp and/or a stationary light lamp of the motor vehicle. Because of this, the number of the components arranged in the front region of the motor vehicle can be reduced in an advantageous manner, which leads to a lower weight of the motor vehicle and a reduced energy consumption and a reduced exhaust gas emission connected with this. In addition, this also makes possible a cost reduction. In the mentioned embodiments, the motor vehicle is for example a passenger car or a commercial vehicle.

### BRIEF DESCRIPTION OF THE DRAWINGS

The present invention will hereinafter be described in conjunction with the following drawing figures, wherein like numerals denote like elements, and:

FIG. 1 shows a motor vehicle according to an embodiment;

FIG. 2A and FIG. 2B show an enlarged view of a region A shown in FIG. 1; and

FIG. 3A and FIG. 3B show an illumination device according to a further embodiment.

### DETAILED DESCRIPTION

The following detailed description is merely exemplary in nature and is not intended to limit application and uses. Furthermore, there is no intention to be bound by any theory presented in the preceding background of the invention or the following detailed description.

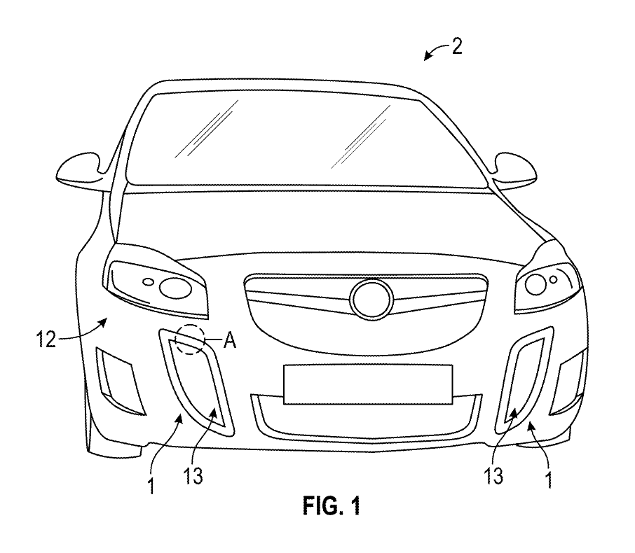

FIG. 1 shows a schematic perspective representation of a motor vehicle 2 according to an embodiment. The motor vehicle 2 in the shown embodiment is a passenger car. In FIG. 1, a front region 12 of the motor vehicle 2 is shown here. The motor vehicle 2 comprises two air inlet openings 13 for providing ambient air for at least one heat exchanger of the motor vehicle 2 which is not shown in more detail, which are arranged in the front region 12 symmetrically with respect to its middle. The at least one heat exchanger is for example selected from the group consisting of an engine radiator unit, an air-conditioning condenser for a refrigerant of an air-conditioning system and a charge air cooler of the motor vehicle 2.

Furthermore, the motor vehicle 2 comprises two illumination devices 1 that are each arranged adjacent to one of the air inlet openings 13. The two illumination devices 1 form a daytime running light lamp of the motor vehicle 2 in the shown embodiment. Furthermore, the two illumination devices 1 can form a parking light lamp and/or a stationary light lamp of the motor vehicle 2. Further details of the illumination devices 1 are explained in more detail in connection with the following figures.

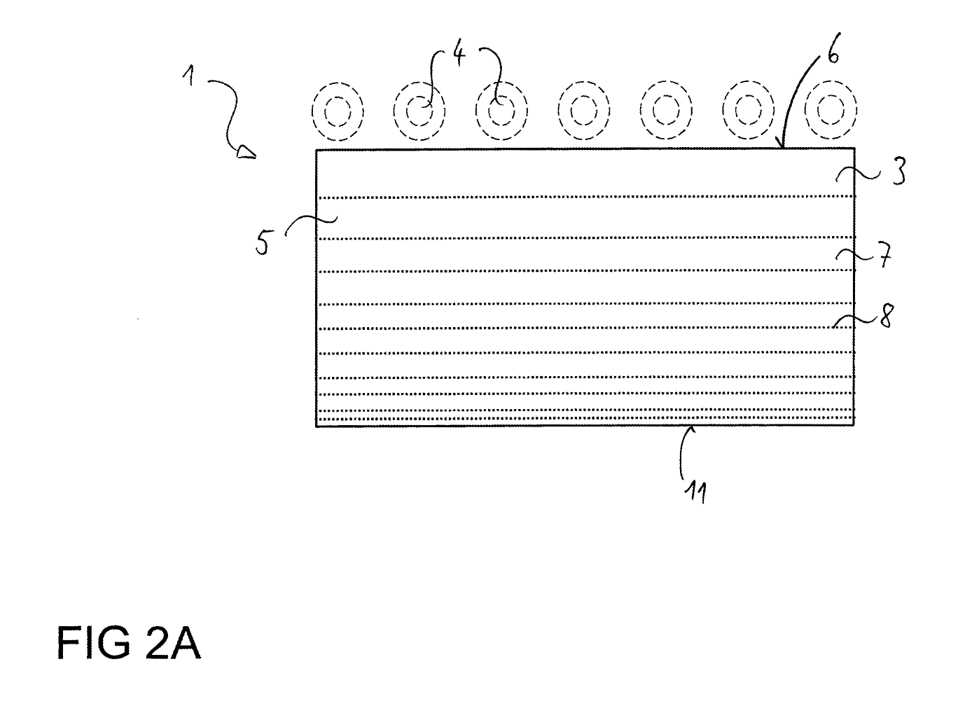

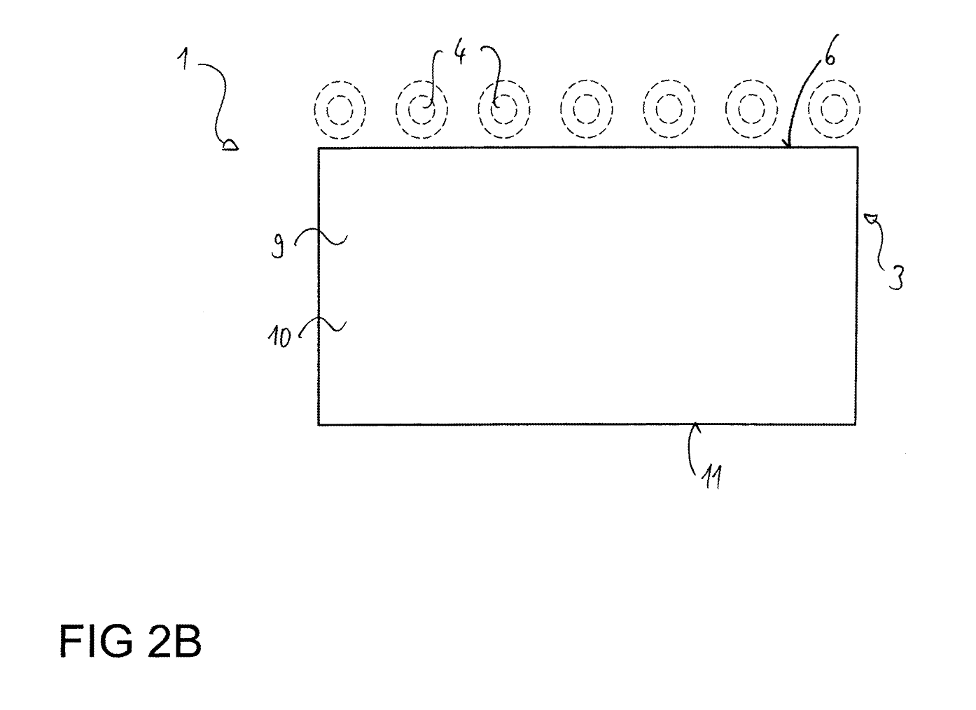

To this end, FIG. 2A and FIG. 2B show an enlarged view of a region A shown in FIG. 1. Components with the same functions as in FIG. 1 are marked with the same reference characters and are not explained again in the following. FIG. 2A in this case shows a top view of a front side of the illumination device 1, i.e., of a side arranged in the direction of the vehicle outside and FIG. 2B a top view of a back side of the illumination device 1, i.e., of a side arranged in the direction of the vehicle inside.

The illumination device 1 additionally comprises at least one light-conductor plate 3, which forms a decorative shaped part 7 of the motor vehicle. The light-conductor plate 3 is fastened to the motor vehicle front structure by means of fastening elements which are not shown in more detail and comprises a first main surface 5 and a second main surface 9 located opposite the first main surface 5. Furthermore, the light-conductor plate 3 comprises a first lateral surface 6 and a second lateral surface 11 located opposite the first lateral surface 6. The first main surface 5 is arranged in the direction of the vehicle outside and the second main surface 9 is arranged in the direction of the vehicle inside. The light-conductor plate 3 additionally comprises light-decoupling elements at least in a part region of the volume of the light-conductor plate 3. In the shown embodiment, the light-conductor plate 3 comprises transparent, light-defusing nanoparticles 8 as light-decoupling elements. For illustration, the light-defusing nanoparticles 8 are shown schematically and not to scale in the figures. As material, the light-conductor plate 3 comprises transparent PMMA, into which the light-defusing nanoparticles 8 are introduced. The material of the light-conductor plate 3 in this case is also called acrylic glass.

In the shown embodiment, an arrangement density of the light-defusing nanoparticles 8 increases from the first lateral surface 6 of the light-conductor plate 3 in the direction of the second lateral surface 11 of the light-conductor plate 3. A corresponding distribution of the light-defusing nanoparticles 8 can improve the even radiation of decoupled light. Alternatively to this, the light-defusing nanoparticles 8 can be homogeneously distributed in the light-conductor plate 3. This makes possible a cost-effective manufacture of the light-conductor plate 3.

The illumination device 1 additionally comprises a plurality of light sources 4, which are embodied as light-emitting diodes in the embodiment shown. The light sources 4 are covered by a covering that is not shown in more detail and thus not visible for a beholder, which is why they are schematically represented in the FIG. 2A and FIG. 2B with interrupted lines. The light sources 4 in the shown embodiment are arranged adjacent to the first lateral surface 6. Thus, the light of the light sources 4 can be coupled into the light-conductor plate 3 via the first lateral surface 6. The light coupled into the light-conductor plate 3 is defused on the light-defusing nanoparticles 8 and because of this can be at least partially decoupled from the light-conductor plate 3 via the first main surface 5.

In a configuration, the light-conductor plate 3 in this case is designed transparently and the light sources 4 are for example designed for emitting white light. Here, the light sources 4 can directly emit white light or the light sources 4 each have a coating by means of which white light is provided. In a further configuration, the light-conductor plate 3 comprises a coloured material. In this configuration, the colour of the light decoupled from the light-conductor plate 3 via the first main surface 5 is determined by the colouring of the light-conductor plate 3. The light sources 4 in this configuration can be designed for emitting light in the colour that is the same as that of the material of the light-conductor plate 3 or for emitting white light.

On the second main surface 9 of the light-conductor plate 3 arranged in the direction of the vehicle inside, said main surface comprises a reflector 10, which in the shown embodiment extends over the entire second main surface 9 of the light-conductor plate 3 and thus entirely covers the second main surface 9. The reflector 10 can for example comprise a semi-transparent coating. Because of this, a light loss through the second main surface 9 facing away from the first main surface 5 can be reduced or avoided.

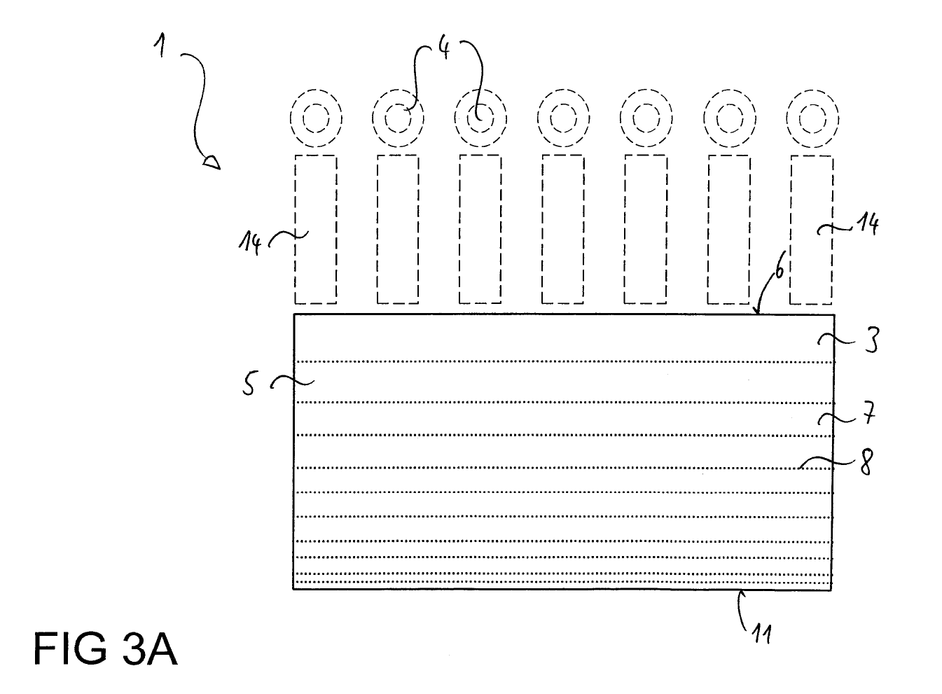

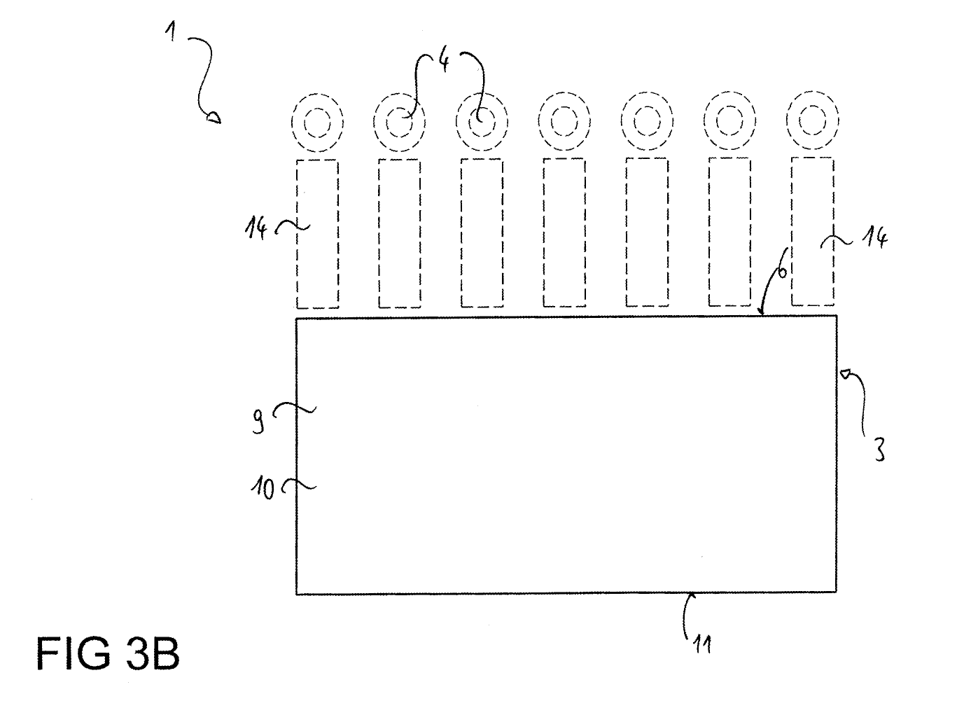

FIG. 3A and FIG. 3B show an illumination device 1 according to a further embodiment. Components with the same functions as in the preceding figures are marked with the same reference characters and are not explained again in the following. FIG. 3 in this case shows a top view of a front side of the illumination device 1, i.e., of a side arranged in the direction of the vehicle outside and FIG. 3B a top view of a back side of the illumination device 1, i.e. of a side arranged in the direction of the vehicle inside.

The illumination device 1 shown in the FIG. 3A and FIG. 3B differs from the illumination device shown in the FIG. 2A and FIG. 2B in that the illumination device 1 comprises a plurality of light conductors 14. The light conductors 14 are likewise covered by the covering that is not shown in more detail and thus not visible to a beholder, which is why they are schematically represented with the interrupted lines in the FIG. 3A and FIG. 3B. The light sources 4 in this configuration are each arranged adjacent to one of the light conductors 14. The light of the light sources 4 can be coupled into the light-conductor plate via the first lateral surface 6 by means of the light conductors 14. This configuration makes possible arranging the light sources 4 further spaced from the light-conductor plate 3. Because of this, the light sources 4 can be arranged for example outside a deformation zone of the motor vehicle.

Although at least one exemplary embodiment has been shown in the preceding description, different changes and modifications can be carried out. The mentioned embodiments are merely examples and not intended to restrict in any way the scope of validity, the applicability or the configuration. On the contrary, the preceding description makes available to the person skilled in the art a plan for implementing at least one exemplary embodiment, where numerous changes in the function and the arrangement of elements described in an exemplary embodiment can be made without leaving the scope of protection of the attached claims and their legal equivalent.

What is claimed is:

1. An illumination device for a motor vehicle, comprising:
a light-conductor plate comprises a first main surface and a first lateral surface and light-decoupling elements at least in a part region of a volume of the light-conductor plate, the light-conductor plate is arranged in an outer region of the motor vehicle and forms a decorative shaped part of the motor vehicle; and
a light source configured for coupling into the light-conductor plate via the first lateral surface and with the light-decoupling elements, the light source configured for decoupling at least partially from the light-conductor plate with the light-decoupling elements via the first main surface.

2. The illumination device according to claim 1, wherein the light-conductor plate comprises polymethyl methacrylate (PMMA) and light-defusing nanoparticles as the light-decoupling elements.

3. The illumination device according to claim 1, wherein the light source is arranged adjacent to the first lateral surface.

4. The illumination device according to claim 1,
wherein the illumination device further comprises a light conductor,
wherein the light source is adjacent to the light conductor, and
wherein a light of the light source and configured to couple into the light-conductor plate with the light conductor.

5. The illumination device according to claim 1,
wherein the light-conductor plate additionally comprises a second main surface located opposite the first main surface, and
wherein the light-conductor plate comprises a reflector on the second main surface.

6. The illumination device according to claim 5, wherein the reflector comprises a semi-transparent coating.

7. The illumination device according to claim 1, wherein the light source is a light-emitting diode.

8. The illumination device according to claim 1, wherein the light-conductor plate has a polygon-shape.

9. The illumination device according to claim 1, wherein an arrangement density of the light-decoupling elements increases from the first lateral surface of the light-conductor plate in a direction of a second lateral surface of the light-conductor plate located opposite the first lateral surface.

10. The illumination device according to claim 9, wherein the illumination device is arranged in a front region of the motor vehicle.

11. The illumination device according to claim 10, wherein the illumination device is arranged adjacent to an air inlet opening for providing ambient air for a heat exchanger of the motor vehicle.

12. The illumination device according to claim 11, wherein the light-conductor plate surrounds the air inlet opening.

13. The motor vehicle according to claim 10, wherein the illumination device is configured to form a daytime running lamp of the motor vehicle.

14. The motor vehicle according to claim 12, wherein the illumination device is configured to form a parking light lamp of the motor vehicle.

15. The motor vehicle according to claim 12, wherein the illumination device is configured to form a stationary light lamp of the motor vehicle.
